(19) United States
(12) Patent Application Publication
(10) Pub. No.: US 2008/0023576 A1
(43) Pub. Date: Jan. 31, 2008

(54) Shower

(75) Inventor: Paul Boesch, Lichtensteig (CH)

Correspondence Address: SUGHRUE MION, PLLC, 2100 PENNSYLVANIA AVENUE, N.W., SUITE 800, WASHINGTON, DC, 20037, US

(73) Assignee: Weidmann Plastics Technology AG, Rapperswil (CH)

(21) Appl. No.: 11/632,489

(22) PCT Filed: Jul. 8, 2005
(86) PCT No.: PCT/CH05/00395

§ 371 Date: Jan. 16, 2007

(30) Foreign Application Priority Data
Jul. 16, 2004 (EP) 04405461.7

(51) Int. Cl. B05B 1/18

(52) U.S. Cl. 239/446

(57) ABSTRACT

Disclosed is a shower comprising a housing (2) that forms a head (K) in which a switchable valve is disposed. Said valve is provided with a sealing member (16) which can be displaced from a first valve seat (12) to a second valve seat (20) in order to switch the type of jet. Actuating means (15) are connected to the sealing member (16). A shower insert (24) encompasses first and second means (26, 27) for forming jets. A shaft (32) in which a duct (10) is located for delivering water to the valve is fixed to the head (K). A sleeve (5) removably slides onto the shaft (32) from a free end. Said sleeve (5) can be interlocked with the housing (2) in the area of the head (K), for example.

The invention relates to a shower according to the preamble of claim 1.

A shower of this type has become known from the state of the art from CH 646 499. This shower is a water outlet fitting for switching from jet to shower. The shower comprises a respective valve seat for a jet outlet and for a shower outlet. The sealing member comprises a switching piston with two lip seals. A shower outlet can be kept open by turning a knob.

Other showers of this type have become known from WO 01/23096, U.S. Pat. No. 5,707,011, and DE 36 43 320 A.

In practice, said showers have proven themselves. Nevertheless, the inventor has undertaken the task of further improving a shower of said type. In particular, it is to be made possible to manufacture the shower according to the invention in an even handier and more cost-efficient manner, and to allow for a particularly appealing design.

The object is solved as claimed in claim 1.

In the generic shower, the sealing member encompasses, on its exterior, a rubber-elastic and radially outwardly projecting sealing means, which cooperates with the first and upper valve seat. It is possible thereby to manufacture a shower with a particularly small and compact head. The said sealing means allows for a sealing of the valve with a comparatively small spring force. This is possible in a particularly reliable manner, if the sealing means is embodied in a discoidal manner. Due to its shape, the sealing means is then particularly flexible and can seal the valve opening with a comparatively small spring force.

A particularly high leak tightness arises if, according to a development of the invention, the sealing means has a hardness of 50-80 Shore, preferably 60-70 Shore, and yet more preferably approximately 70 Shore.

If the sealing member encompasses a lower sealing surface, which cooperates with the second and lower valve seat, and which is formed by a comparatively hard material, a particularly low overall height of the head can be achieved. Nonetheless, the valve seals reliably in both positions.

A particularly simple and cost-efficient embodiment arises if, according to a development of the invention, the second and lower valve seat is formed by a rubber-elastic sealing element. Preferably, this sealing element is installed into a sleeve-like part of the shower insert in a sealing manner. The rubber-elastic sealing means thus has a double function and thus serves as a valve seat and also for sealing the shower insert.

In an alternative of the shower according to the invention, the sleeve is placed so as to be capable of being removed from the free end of the shaft. This allows for a modular configuration, where the shower can optionally be provided with different sleeves. The sleeve of the shower can later also be replaced with another sleeve. This-is particularly simple, if the sleeve is interlocked according to a development of the invention. Preferably, the sleeve is interlocked with the head in the area of the head of the shower. Preferably, provision is made here for a removably interlockable actuating means. For example and preferably, this actuating means is a button, which is disposed in an opening of the sleeve. During assembly, the housing with the valve and the shower insert can be completed and all of its functions can be tested.

Subsequently, the desired sleeve is attached and, finally, at best, the actuating means or the button is attached or interlocked. With a favorable storage, this allows for a simple assembly and delivery.

If the sleeve has an opening on its lower side, into which extends a shoulder of the housing, an effective impact protection can be achieved. Preferably, this shoulder slightly projects above the exterior of the sleeve. If the shower strikes on an edge of a pan, for example, the sleeve is not damaged. Preferably, the shoulder is a lamellar web and, preferably, said opening of the sleeve is open towards the front. Here, the sleeve can thus also be slid onto the shaft of the housing.

With the shower according to the invention, provision is made according to an alternative for the volume of the head to be less than 56 m², preferably less than 40 m². The result of the smaller construction of the head with reference to its volume is a substantially simpler and safer handling, as well as a particularly advantageous esthetic design.

Other advantageous features result from the dependent patent claims, from the following description, and from the drawing.

An exemplary embodiment of the invention will be explained in more detail by means of the drawing. It is shown:

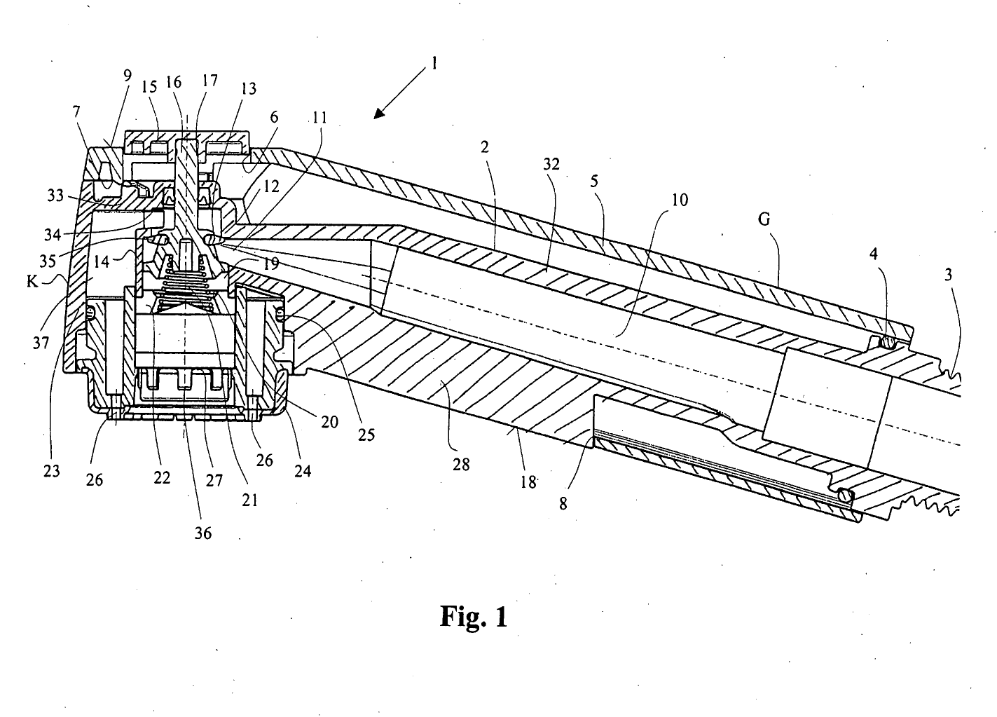

FIG. 1 a section through a shower according to the invention,

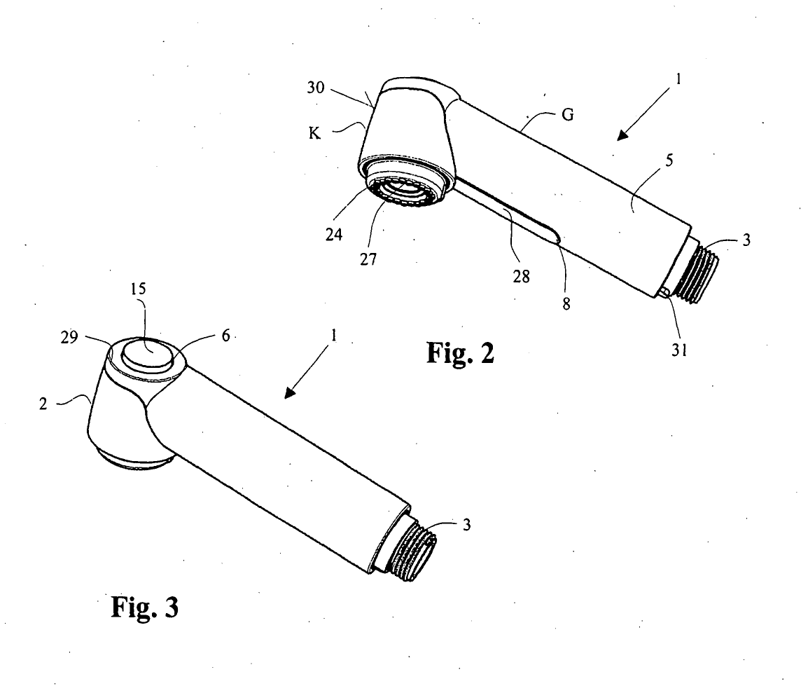

FIG. 2 a spatial view of the shower according to the invention, and

FIG. 3 another view of the shower according to the invention.

The shower 1 illustrated in FIG. 1 comprises a housing 2, which, preferably, is made of a plastic in an injection molding process in one piece. The housing 2 comprises a wall 23, which substantially forms a head K, on which a shaft 32 which forms a handle G with a sleeve 5 is integrally molded. At one end, the shaft 32 comprises a water connection section, such as a thread 3, for connecting the shower 1 to a flexible hose, for example, which is connected with a water supply line. A duct 10, which leads into the head K at a mouth 11, runs through the shaft 32.

In its interior, the head K comprises a sleeve-like guide part 14, which is open towards the mouth 11, and in which a sealing member 16 of a switching valve is displaceably positioned. The guide part 14 has an upper opening 35, which forms a first valve seat 12. In the position of the sealing member 16 illustrated in FIG. 1, said guide part 14 abuts on this valve seat 12 with a rubber-elastic ring or with a discoidal sealing means 13. The contact pressure is formed by a spiral spring 21, the one end of which is supported on the sealing member 16, and the other end of which is supported on an inherently known aerator 27. As can be seen, the sealing means 13 protrudes radially and is embodied in an aliform manner. From an axial point of view, the sealing means 13 is flexible and is made of a comparatively flexible plastic. For example and preferably, the plastic is EPDM and has a hardness of 50-80 Shore, preferably 60-70 Shore, and yet more preferably approximately 70 Shore. Due to the said design and due to the high elasticity, the sealing means 13 allows for a sufficient leak tightness, even if the valve seat 12 has a comparatively small diameter and if, at the same time, the spring 21 is comparatively weak. This allows for a particularly small overall height of the head K.

The sealing member 16 has a front side 19, which forms a seal, and which cooperates with a second valve seat 20, which is formed by an annular sealing means 22. This sealing means 22 abuts on a lower edge of the sleeve-like guide part 14. Preferably, the sealing means 22 is embodied in one piece and has a hardness of 10-80 Shore, preferably 60-70 Shore, and yet more preferably approximately 70 Shore. For example, the sealing means 22 is also made of EPDM.

Furthermore, the sealing means 22 abuts on the aerator 27 and seals the same in relation to the housing 2 and in relation to a shower insert 24.

If the sealing member 16 in FIG. 1 is moved by means of a pressure downwards onto a plate-shaped button 15 or onto another suitable actuating means, the sealing member 16 or the surface 19 moves contrary to the retroactive force of the spring 21 against the second valve seat 20. If the surface 19 bears on the second valve seat 20, a pass 36, which leads to the aerator 27, is closed. On the one hand, the leak tightness is ensured by the rubber-elastic sealing means 22 and by the comparatively hard sealing member 16. If the sealing member 16 is in the lower position, the water flows through the mouth 11 into the guide part 14 and through the opening 35 into a space 37. From this space, the water reaches the exterior through nozzle openings 26. By means of the pressure of the water in the guide part 14, the sealing member 16 is held on the second valve seat 20 against the effect of the spring 21. By restricting the water supply, the pressure or the force onto the sealing member 16 can be reduced in such a way that it returns into the upper position shown in FIG. 1. In principle, however, return means are also possible here, with which the sealing member 16 can be returned into the position shown in FIG. 1. Such return means have become known in the state of the art in numerous designs.

If the sealing member 16 is in the position shown in FIG. 1, the water flows from the mouth 11 through the pass 36 into the aerator 27 and leaves said aerator 27 as a correspondingly bubbling stream. The shower insert or insert 24 thus has first and second means for forming a jet. The first means are the nozzles 26 and the second means is the aerator 27. The inherently known aerator 27 is inserted into the shower insert 24 from the top and can be cleaned or replaced, if the insert 24 is removed. In principle, an aerator 27 or another suitable jet forming means, which is inserted into the shower insert 24 from below, for example screwed in, is also possible.

The insert 24 is inserted into the head K with a non-illustrated bayonet catch or with another suitable catch, a common thread, for example. Sealing means 25 are provided for sealing the insert 24 in relation to the housing 2.

The sleeve 5 can encompass a refined or optical outer surface, such as being chrome-plated. The sleeve is removably slid onto the shaft 32. At its front end, it encompasses a ring 29 with an annular surface 9 and a preferably circular opening 6, into which the button 15 engages or into which the-button 15 is inserted. The button 15 encompasses a latching means 17 or another suitable connection means, with which the button 15 is removably connected with the sealing member 16. Below the annular surface 19, latching means 7, which cooperate with corresponding latching means 33 of the housing 2, are integrally molded on the interior of the sleeve 5. The latching means 7 and 33 are embodied in such a manner that, if the button 15 is removed, the sleeve 5 can be slid onto the housing 2 or onto the shaft 32 and can be removed again, after removing the button 15.

On its lower side, the sleeve encompasses an oblong opening 8, which is open in the front, into which a corresponding shoulder 28 extends. With a lamellar surface 18, this shoulder 28 slightly projects above the opening 8, preferably up to 2 mm, as is shown in FIG. 1 with approximately 0.5 mm. FIG. 2 also shows the configuration of the shoulder 28 with regard to the handle G. The web-like shoulder 28 forms an impact protection. On impact of the lower side of the shower 1 onto an edge of a pan, for example, the sleeve 5 is not damaged. However, the shoulder 28 made of plastic can absorb such an impact without being further damaged. A cam 31 integrally molded on the housing 2 (FIG. 2) prevents a twisting of the sleeve 5.

As particularly shown in FIG. 3, the head K encompasses a comparatively small outer diameter and a comparatively small overall height. An exterior 30 of the head K is substantially conical and clearly visible. The head K does not substantially project above the handle on the upper side. Only the button 15, which is operated here with a thumb, for example, protrudes at the upper side. Preferably, the height of the head K, including the button 15 and the shower insert 24, is less than 56 m³, preferably less than 40 m³. The example shows a band with approximately 37 cm³ with a height of approximately 43 mm. Preferably, the height of the head K, including the button 15 and the shower insert 24, is less than 50 mm, preferably less than 45 mm. As shown in FIGS. 2 and 3, the head K is substantially conical, whereby the greatest outer diameter of the head K is preferably less than 50 mm. Preferably, the greatest diameter is less than 45 mm and the median outer diameter is approximately 35 mm. A particularly handy and shapely shower can thus be manufactured. Furthermore, the shower according to the invention consists of comparatively few and robust parts. The shower can be manufactured in a particularly cost-efficient manner and its storage and assembly, with reference to the production in view of said modular configuration, is also particularly favorable. As already mentioned, all of the functions of the shower 1 can be tested before the sleeve 5 is slid on. By manufacturing the housing 2 and the sleeve 5 with different colors, surface structures and/or materials, the appearance can be changed in a simple and versatile manner.

### List of Reference Numerals

1 shower
2 housing
3 thread
4 sealing ring
5 sleeve
6 opening
7 latching means
8 opening
9 surface
10 duct
11 mouth
12 valve seat
13 sealing means
14 guide part
15 button
16 sealing member
17 latching means
18 surface
19 front side
20 valve seat
21 spring
22 sealing means
23 wall
24 insert
25 sealing ring
26 nozzle opening
27 aerator
28 shoulder
29 ring
30 exterior
31 cam
32 shaft
33 latching means
34 seal
35 opening
36 pass
37 space
G handle
K head

1.-25. (canceled)

26. A shower comprising:
a housing, which forms a head,
a switchable valve disposed in said head, said switchable valve comprising (1) a sealing member, which can be displaced from a first valve seat to a second valve seat in order to switch the type of jet, (2) actuating means, which are connected with the sealing member, and with a shower insert, which is removably fixed to the head, said shower insert comprising first and second means for forming jets,
wherein on its exterior, the sealing member comprises a rubber-elastic and radially outwardly projecting sealing means, which cooperates with the first valve seat.

27. The shower as claimed in claim 26, wherein the sealing means is embodied in a discoidal manner.

28. The shower as claimed in claim 26, wherein the sealing means has a hardness of 50-80 Shore, preferably 60-70 Shore, and yet more preferably approximately 70 Shore.

29. The shower as claimed in claim 26, wherein the sealing member comprises a lower sealing surface, which cooperates with a second and lower valve seat, and which is formed by a comparatively hard material.

30. The shower as claimed in claim 26, wherein the second and lower valve seat is formed by a rubber-elastic sealing means.

31. The shower as claimed in claim 30, wherein the rubber-elastic sealing means is installed into a sleeve-like part of the shower insert in a sealing manner.

32. The shower as claimed in claim 30, wherein, at an upper side, the rubber-elastic sealing means abuts in a sealing manner on a sleeve-like guide part, the sealing member being displaceably seated in said sleeve-like guide part.

33. The shower as claimed in claim 30, wherein the sealing means is embodied in one piece, and has a hardness of 10-80 Shore, preferably 60-70 Shore, and yet more preferably approximately 70 Shore.

34. The shower as claimed in claim 26, further comprising a spring, which clamps the sealing member against the first and upper valve seat, said spring being disposed between the sealing member and an aerator, whereby the spring is supported on the aerator.

35. A shower comprising:
a housing, which forms a head,
a switchable valve disposed in said housing, said switchable valve comprising (1) a sealing member, which can be displaced from a first valve seat to a second valve seat in order to switch the type of jet, (2) actuating means, which are connected with the sealing member, (3) a shaft attached to the head, (4) a water duct, one end of which is adapted for connection with a water line and being arranged in said shaft, and
a sleeve, which is removably placed on the housing from said end.

36. The shower as claimed in claim 35, wherein the housing comprises an integrally molded shaft, onto which the sleeve is placed in a removable manner.

37. The shower as claimed in claim 35, wherein the sleeve is interlocked.

38. The shower as claimed in claim 35, wherein, at a front end, the sleeve comprises latching means for anchoring the sleeve on the housing.

39. The shower as claimed in claim 35, wherein the actuating means comprises a button, which is removably interlocked on the sealing member.

40. The shower as claimed in claim 35, wherein the sleeve extends in the area of the head.

41. The shower as claimed in claim 35, wherein the sleeve comprises a ring in the area of the head, said ring encompassing an actuating means.

42. The shower as claimed in claim 41, wherein the ring is interlocked at the head.

43. The shower as claimed in claim 35, wherein it is constructed in a modular manner and in that all of the functions of the valve can be tested before the sleeve is slid on.

44. The shower as claimed in claim 35, wherein the head is surrounded by the sleeve, substantially only in the area of the actuating means.

45. A shower comprising:
a housing, which forms a head,
a switchable valve disposed in said housing, said switchable valve comprising (1) a sealing member, which can be displaced from a first valve seat to a second valve seat in order to switch the type of jet, (2) actuating means, which are connected with the sealing member, (3) a shower insert, which is removably fixed to the head, said shower insert comprising first and second means for forming jets, and
a handle formed by a sleeve, which, on a lower side, encompasses an opening, into which extends a shoulder of the housing, whereby this shoulder serves as impact protection.

46. The shower as claimed in claim 45, wherein the housing encompasses an integrally molded shaft, onto which the sleeve is placed in a removable manner.

47. The shower as claimed in claim 46, wherein the sleeve is interlocked on the housing.

48. The shower as claimed in claim 45, wherein, at a front end, the sleeve encompasses latching means for anchoring the sleeve on the housing.

49. The shower as claimed in claim 45, wherein the actuating means encompass a button, which is removably interlocked on the sealing member.

50. The shower, in particular as claimed in claim 45, wherein it is constructed in a modular manner, and in that a sleeve is slid onto the housing, whereby all of the functions of the shower can be tested before the sleeve is slid on.
